(19) United States
(12) Patent Application Publication
(10) Pub. No.: US 2016/0013994 A1
(43) Pub. Date: Jan. 14, 2016

(54) System for Gathering Music Intelligence

(71) Applicants: Dave Jimison, McLean, VA (US); Pete Jimison, New York, NY (US); Jenifer Vandagriff, Brooklyn, NY (US); Matthew Cullerton, Carlsbad, CA (US)

(72) Inventors: Dave Jimison, McLean, VA (US); Pete Jimison, New York, NY (US); Jenifer Vandagriff, Brooklyn, NY (US); Matthew Cullerton, Carlsbad, CA (US)

(21) Appl. No.: 14/515,325

(22) Filed: Oct. 15, 2014

Related U.S. Application Data
(60) Provisional application No. 61/891,531, filed on Oct. 16, 2013.

(51) Int. Cl. H04L 12/26

(52) U.S. Cl. CPC H04L 43/04

(57) ABSTRACT

A system for gathering musical intelligence. The system has a server digital device operatively connected to a distributed network and a client digital device operatively connected to the distributed network and configured to collect and musical intelligence received from the server digital device through the distributed network.

### CROSS REFERENCE TO RELATED APPLICATIONS

This application claims priority to U.S. Provisional Patent application 61/891,531 filed Oct. 16, 2103, the substance of which is hereby incorporated by this reference as if fully set forth herein:

### TECHNICAL FIELD

This disclosure relates to a system for gathering musical intelligence.

### BRIEF DESCRIPTION OF DRAWINGS

FIG. 1 is a schematic representation of an aspect of the system.

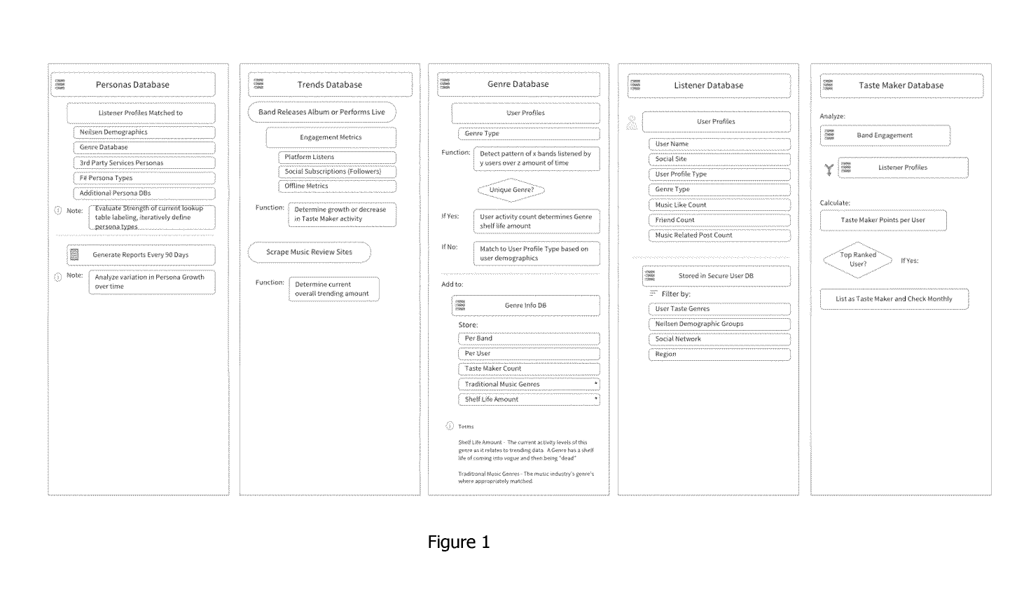

### DETAILED DESCRIPTION

A system for the computer based monitoring and analysis of cultural trends in entertainment media and for providing a framework for evaluating such trends into quantifiable measures is disclosed. This document begins with Foundational concepts, a section which defines a particular viewpoint of entertainment media, and involves establishing core terminology by which to quantify entertainment media and better analyze consumer engagement with it. This section is followed by details of the key components of the system and their interoperability with the larger infrastructure.

Our research is based upon both cultural and media studies as well as artificial intelligence such as neural networks and pattern matching One of the components of the system are the methods by which human input is gathered and integrated into a knowledge base.

The output of the system is provided in a series of formats ranging from cyclical reports to interactive forecasting info-graphics. These outputs are intended for a series of user types from external subscribers of the system to our software engineers. The section entitled Trending Detection & Reporting provides an overview of some of the key methods by which information is managed and distributed.

Foundational Concepts

The concepts in this document rely upon a set of terms that typically describe aspects of culture and media, but which, in the general public, have ambiguous definitions. It is necessary to not only define what is meant by each of these terms, but also to establish the methodologies for how these terms are then instantiated in computer software. As the software and analysis models rely heavily upon the ability to deconstruct and analyze media, the following definitions are a component of the system.

Media

Media is used in this document to describe an artifact of the creative process. Media is the specific form in which content is inscribed onto, such as audio, video, interactive web page, or videogame. Each media form has unique affordances which its content should leverage to maximize impact.

Creation

The individual unit of media which can stand on its own as a complete work. This can range from a book to a song to a movie trailer, however it would not be considered a musical motif or a chapter of a book, as each of these is considered to be portions of the larger creation.

Creator

The primary person or persons who thought of, inscribed, and/or built the creation. The creator would be considered any person who exhibited significant influence over the creation, without whom, the creation would not be the same. The difference would be a lead guitarist with a signature style such as Slash of Guns-n-Roses, as opposed to a studio musician hired to play a portion of the composition.

Tastes

Taste is a set of preferences for what is liked and disliked within culture. This taste can be applied both on the individual level and to a particular portion of the populace. Thus, it can be said that one's tastes are for avant-garde classical music, while the general tastes of the United States are for the more traditional 19th century romantic forms.

A taste is determined by a type, or shared pattern, within the style of the media form. For instance, were one's tastes to include the fast intense discordant guitars of thrash metal bands Anthrax and Judas Priest, it can be adequately assumed that these tastes would then extend to musicians with similar styles such as Pantera and Venom.

Tastes are not only allotted to specific type of media, but can further be defined by an intensity applied to them. A person can be said to love a particular film, or actively hate another. The intensity is noted by its differentiation from the general baseline of media in the same form. The intensity of a taste is qualified by the amount of energy spent pursuant to such a taste in expression, behavior, and spending.

The system qualifies an individual's taste by the intentional action performed, or in some instances not performed, by the person. Here are a few examples:

Liking a brand page on Facebook

Refusing to see a movie based on it being a “chick flick”

Watching the entirety of a movie trailer advertisement on a website, rather than clicking the “skip ad” button

In each of these and similar instances the tastes of the person are established by what they do in relation to their typical behavior, and the level of energy they are expending in pursuing the engagement of taste in their lives.

Tastes are important to an individual in providing a sense of identity. Taste “functions as a sort of social orientation, a ‘sense of one's place’, guiding the occupants of a given place in social space towards the social positions adjusted to their properties, and towards the practices or goods which befit the occupants of that position.” Tastes thus are incredibly important in understanding the motivations and behaviors of an individual. Tastes manufacture and direct our desires. The choice of using or free time to see a movie is based upon our tastes, both in the determination to see a movie and the selection of which movie.

However, tastes are often culturally determined, and can be both influenced and can change over time. Tastes are as stable as other aspects of a person's personality and belief system, and as a person calcifies into an established identity, it can be expected that their tastes will change less.

The accumulation of tastes within a specific media form can also be beneficial in understanding a person. Often, individuals accumulate a significantly larger series tastes within one specific media form over others. For instance, an individual may have several tastes in music but not literature, or vice versa. The person with more tastes in one media form at a much higher level than the average is defined as an aficionado. Aficionados can be expected to engage regularly in the consumption of media in their particular form, and be highly knowledgeable about the form.

Aficionados are not necessarily expressive of their tastes to society. Many can exhibit introverted behaviors, keeping their tastes to themselves. However, tastes can be a component of cultural exchange between persons, and some individuals appear to be far dominant in their influence of tastes upon others. These tastemakers will have a group of people with similar tastes, with whom they share their influence. Tastemakers are early adopters of media content. The tastemaker will engage in discovering new creations that match the taste and then disperse this to their larger group. Examples of this are:

A Movie Critic

A music enthusiast who takes pride in sharing the newest discovery with their friends on social networks

Tastemakers are incredibly important for incorporating new material. Our section on Tastemaker Tracker will describe how they are incorporated into the system.

Other music services offer methods of providing taste recommendations based on past user performances. For example, Mood Agent and Echonest rely upon creating a musical signature, or fingerprint of the song, using music analysis software to dissect the musical aspects to a song into such factors as rhythm, tone, and emotional impact. Last.Fm uses the past listens of other users to make recommendations. Our strategies for determining tastes are described later in this document, but rely on advanced abstraction of tastes, and the utilization of algorithms to the current growth potential of the trend.

Tastes might be formed on the individual level, but they can also be evaluated as a social collection. Individuals with shared tastes, often share some beliefs and behaviors, and consequentially form social relations around their tastes. One of the clearest depictions of this is in the category of subculture. Subcultures are groups of shared tastes who define themselves in contrast to their larger society through a set of rituals, coded dress, and behaviors. Research has shown that there is a distinct pattern match between these groups of shared tastes and purchasing behavior, which is the premise of our Vand 2 Brand concept.

Trends

Tastes have life cycles that can be quantified both by the number of adherents to the taste and the amount of cumulative energy being expended towards it. The “rave scene” of the early 90s began as a niche type of music in the late 80s, derived from previous electronic music styles. The music became popularized by DJs at underground parties and dance clubs, leading to its growth in popularity amongst the general populace. As the “rave scene” grew massive with more traditional listeners, the style calcified into a more predictable set of qualities, which ultimately resulted in the music largely being viewed as cliche by the early adopters and tastemakers.

We define birth of the “rave scene” trend as the moment when the music reached a critical mass of adherents and tastemakers. We are concerned with detecting emerging trends, and thus it has set the threshold for qualifying a trend rather low.

The death of the “rave scene” is the point when the growth passes its apex. We borrow the definition of death from Paul Mann's The Theory Death of the Avant Garde (1991) which provides an excellent context for when a scene is dead. The death of a trend results in its calcification of form, and at this point the system considers the state of the trend to that of being archived in its format. As a dead trend, it is referenced but would not be considered changed. Any changes or new additions to a dead trend would be rather considered birth of new offshoot scenes. The rave scene birthed other trends such as trance, happy hardcore, and jungle. More recently, a resurgence of interest trend has been found in emerging bands such as Slava and Teengirl Fantasy. The music of these revivals, again, is not considered to be additive to the initial trend, but rather a new trend with its own lifecycle.

System Components

This section outlines the different components of the system, each of which target specific functionalities of the software. The system differentiates these components in order to explain some of their theoretical and software variations. The system is intended to operate as a whole software system, and many of these components rely upon each other for full functionality.

Brand 2 Band

Brand 2 Band is a software based music recommendation system that matches musical creators (“bands”) to specific brand products. Brand 2 Band allows for the input of a series of demographic and psychographic information to be input into a search form. This information is then correlated to the musical qualitative terms and biographical information used to describe a band. Brand 2 Band can also be used to select a specific musical trend and view brands and other products that people who listen to the music also like. These two sets of information combined provide a powerful matching tool for marketers looking to amplify their market reach with music.

Brand 2 Band gathers information from two sources: System database systems, in particular the Listener Profile Database. The part of our databases use third party resources of mood and music styling to match music artists to the key psychographic words of a brand campaign. We have created a direct correlation between the two, assigning corresponding musical values to the plethora of descriptive terms used by marketers to describe their campaign products. Additional information about the band includes biographical data, current and upcoming tour schedule (where available), and hot zones of popularity. The listener profile database (described in detail later) matches particular persona types with their musical tastes and their purchase behaviors and stated product preferences.

Brand 2 Band provides users an easy user interface to add and filter selections, sampling the selected data and then outputting it for later use. For example:

After inputting brand information, the user can view and filter through matching bands. They can see available filter options, and can click “more like this” to have more band options provided. They can also click to listen to the band's music and learn who handles rights management for the band.

After inputting music information, the user can see products which have been matched to the music trend. By mousing over the products, the reasons for their matching are clearly depicted.

Brand 2 Band strives to navigate the legal complications of band licensing as quickly and easily as possible, while maintaining fair equity for the bands. In their Emerging Artists program, F# uses its Trending Detection & Reporting (described in detail later) to identify new artists quickly growing in popularity, and pre-emptively approach these artists to acquire licensing rights. The system's Emerging Artists are visually distinct, enabling brands to quickly view the terms for licensing, and sign for their campaign.

Dynamic Trend Detection

Genre is a category of creation in a specific media which exhibits stylistic similarity. The problem with conventional usage of genre is that it is an industry applied categorization, done oftentimes much after the actual development of the actual styles being categorized. When a new trend is emerging, there tends to be a period of confusion while a new descriptive term is applied to it. This problem has previously been circumnavigated by industry by parenting genre within branching trees, with between 5-7 master genres. For instance, Grand Master Flash, Eminem, and Tyler the Creator would all find themselves within the same genre of hip hop, despite having rather substantial stylistic differences and fans.

The system handles this problem differently, by acknowledging that genre is best abandoned in preference for trend under the following definition.

The system process is as follows:

1. Continually monitor media consumption activity to detect new patterns across artists.

Trend=n*n1 users engage x*x1 set of creations over y amount of time Formula Overview
Where n1, x1, and y are fluctuating variables; n1+x1+y=1/trend strength

2. Upon detecting a trend over a threshold trend strength, the system establishes a new set of descriptors for the trend including identifying key creators and tastemakers. In addition, the system attempts to situate the trend within a historical cultural context, by looking at the lineage of influencers upon the creators. This information is used to assign a name to the trend where possible.

The system uses a modified genetic algorithm to test the strength of the trend in comparison to alternative trends. The system establishes that the discovered trend has a genetic composition wherein the artists are considered chromosomes. It then select artists with similar mood and musical stylings, and introduce them as mutations. These mutations then compete with the original trend for taste matching with the users tastes. This competition further determines which genetic composition is uniquely dominant as that combination compared with other genetic compositions. The winning genetic composition is compared to the initial genetic composition of the trend. The results provide an understanding of which bands are outliers to the core of the trend.

3. Having established the creators of the trend, the system uses the Tastemaker Tracker to identify which tastemakers were discussing the creators favorably.

4. The system monitors activity in the trend to detect fluctuation in its life cycle. This monitoring includes:

a. Media consumption charts from album sales, radio, streaming services, and torrent downloads

b. Adding new creators to the genre definition by looking for the addition of creator to a majority of trend adherents

c. Tastemaker Tracker information

d. Adding and removing adherents by detecting the pattern of shared musical tastes within their media consumption

5. When a trend reaches past its apex for x amount of time, it becomes listed as dead. The system archives the information and ceases monitoring.

The Dynamic Trend Detection component is superior to traditional media nomenclature systems such as genre labeling, because it operates based on statistical evaluations of media consumption. It provides the capability to produce unlimited sets of trends and prioritize them based on their strength within the general populace. Finally, it can dynamically alter the key creators and adherents of the trend and determine its current lifecycle state.

Tastemaker Tracker

The Tastemaker Tracker is a software system to identify tastemakers, capture and analyze the products of their tastemaking, and evaluate the effectiveness of their tastemaking output.

Tastemakers are by their nature prolific in sharing their tastes with a larger audience. It is by the process of disseminating their opinion and influencing the tastes of others that they establish their own value. Professional tastemakers are easily identifiable by their more traditional arenas of dissemination such as the radio, blogs and critical reviews. The system incorporates a number of custom web scrapers to parse known tastemaker sites and integrate the output of these into our own knowledge set.

Tastemakers extend beyond this to the sharing of media through social networking with a distinct group of friends. For instance, some tastemakers are simply consistent early adopters of media that their social network will like, and have a habit of sharing it online. Online media services have manifested a space for this tastemaker with elements such as the Spotify Follow and the Youtube Playlist. The system monitors user behavior for evidence of being a tastemaker, and evaluates users on their tastemaking level as influencers.

Tastemaker output is highly unstandardized, with no distinct corollary between tastemaker review and recommendations. Rolling Stone uses five stars while Pitchfork uses a 1-10.0 scale to review music. The more specific the tastemaker's field of review, the less likely there is a standardized review system. Cultural magazine VICE uses illustrations of smiley faces and puking face to denote their reviews. Eclectic music magazine The Wire does not post any scale. Due to this lack of coherent standards in reviews, Tastemaker tracker distills each review system into a positive and negative review. This simplifying of the review system into binary terms is effective when viewed in conjunction with multiple review sources. For instance, if the accumulation of 10 resources are positive for a new album, this is far better than if only 7 or 3 of the sources do.

The cumulative reviews of a creation enable the system to process and understand the value, however, the system furthers this understanding greatly by adding in contextual weights to each of the tastemakers reviews. Each tastemaker is given associated with particular trend(s) to which they have established influence. For example Pitchfork is given additional weight when the evaluation is an indie band, and lesser weight when it is a pop boy band popular with teenage girls. These weights provide for their to be different understanding of how the band is performing within different trends.

The final aspect of the tastemaker tracker is to evaluate the effectiveness of the tastemaker. At key interstitial points, the software compares the binary review from the tastemaker with the overall performance of the creation in the marketplace. The system integrates downloads, purchases, radio plays, and other information to get a general analysis of how many engagements with the creations occurred. The system then compares that to the creators history and other similar creations to determine whether it was a success or not. Next the system compares the success of the creation to the initial review of the tastemaker. The ability of a tastemaker's review to predict the success of a creation is thus determined, and affects their weight.

Listener Profile System

The Listener Profile System tracks the user tastes and behaviors of people who have interacted with our apps or advertisements at the point of interaction, and pools that data into particular personas. For example, when a user creates a mixtape to send to their friend with the system ad platform, they must connect to Facebook, and in doing so provide us a listing of their current listening activity and likes.

The Listener Profile System retains a set of user personas that are based upon the most active personas targeted in advertising campaigns. When the system analyzes an individual users data, it determines which persona best apply, and then adds their tastes to the overall profile of that persona. As more users tastes are added to the personas, the system is able to depict trends of tastes within particular user personas.

User personas are collated and mapped to third party advertising demographic standards. An example of this is the Nielsen market segmentation which breaks down media consumers into segments such as “Globe Trotters”, “School Daze” and “Savvy Savers”. The system matches these already well defined demographics sought after by advertisers and adds the additional information of musical tastes, helping to better define the demographic and also providing a better understanding of access through entertainment media

The Listener Profile System also enables easy aggregation of third party data resources regarding profiles into its databases, enabling the increasing complexity and nuanced understanding of the individual groups. The system is built to scale through the integration of third party consumer purchase data. The integration of such consumer purchase data would provide more detailed connection between specific brands and the listeners of specific profiles.

Trending Detection & Reporting

The final component of the system is the Trending Detection & Reporting system which allows for setting alerts on specific aspects of the system and receiving reports on the information.

The system user interface allows for every aspect of the information to be browsable, and for alerts to be set upon specific aspects with thresholds. For instance, a user can request to receive an alert when a specific trend reaches a set number of adherents, or when a band receives reviews. These alerts are emailed as reports which include the requested alert and a graphic depicting the overall information.

The Trending Detection and Reporting System is also responsible for creating information for cyclical press releases. Such releases cover key trends and changes in the media landscape as well as emerging creators. Each release is intended to raise awareness of the capabilities of the system with a larger audience, and attract them to the system website.

Potential

The system has the potential to dramatically transform the potential for brands to hyper-target their desired market by determining the best media creation to be associated with. The system provides a systematic comprehension of cultural relevancy for all actors within the media landscape from tastemakers to creators, and a method for quantifying these behaviors in order to gain significant insight.

The system is built for the music space, in large part to take advantage of the current momentum in on demand ad supported music content with providers such as Spotify and YouTube. Other music services, including Songza, Soundcloud, and Official.FM each have their own unique methods of engaging an audience of music lovers, and each could benefit from using the system to better relate brands to music artists.

The system algorithms and databases are built with a layer of abstraction, enabling the knowledge and software techniques refined on music to be easily applicable to other media forms from film to literature and videogames. Many of the traits which are currently applied for detection of music tastes such as profiles and incorporating external review sites, can be quickly modified for other media forms.

The system is unique in its integration of human derived outputs around media from tracking media consumption to scraping and analyzing reviews from tastemakers. While being a sophisticated set of software, the system retains a flexible set of inputs for human and cultural input. The system intentionally stands on the shoulders of giants and is determined to use third party data sets whenever possible, while not requiring any of them for its operation. Finally, the system delivers information to users in both the brand and music industries that enable each to use the knowledge the system generates to better engage each other in their future endeavors.

We claim:

1. A system for gathering musical intelligence, the system comprising:
a server digital device operatively connected to a distributed network;
a client digital device operatively connected to the distributed network and configured to collect and musical intelligence received from the server digital device through the distributed network.

2. The system of claim 1 further comprising continually monitoring media consumption activity to detect new patterns across artists, according to the formula
Trend=n*n1 users engage x*x1 set of creations over y amount of time;
Where n1, x1, and y are fluctuating variables; n1+x1+y=1/trend strength.
